(19) United States
(12) Patent Application Publication
(10) Pub. No.: US 2022/0161495 A1
(43) Pub. Date: May 26, 2022

(54) 3D Printing

(71) Applicant: Hewlett-Packard Development Company, L.P., Spring, TX (US)

(72) Inventors: Arnau Codina Saborit, Sant Cugat del Valles (ES); Pol Fornos Martinez, Sant Cugat del Valles (ES); Vanesa Fal Miyar, Sant Cugat del Valles (ES); Ismael Fernandez Aymerich, Sant Cugat del Valles (ES)

(73) Assignee: Hewlett-Packard Development Company, L.P., Spring, TX (US)

(21) Appl. No.: 17/414,465

(22) PCT Filed: Jul. 22, 2019
(86) PCT No.: PCT/US2019/042775

§ 371 Date: Jun. 16, 2021

(51) Int. Cl. B29C 64/314; B29C 64/393; B29C 64/165; B33Y 10/00; B33Y 30/00; B33Y 50/02

(52) U.S. Cl. CPC B29C 64/314; B29C 64/393; B29C 64/165; B29C 64/357; B33Y 30/00; B33Y 50/02; B33Y 10/00

(57) ABSTRACT

Examples relate to a 3D printing and a method comprising receiving a packing ratio of an object to be printed; based on the received packing ratio, determining a mixing ratio of fresh to recycled build material to use for printing the object; and providing the mixing ratio to a dispenser to dispense fresh and recycled build material in the provided mixing ratio for printing the object.

### BACKGROUND

Three dimensional printers are revolutionising additive manufacturing. Often, a mixture of fresh and recycled build material is used to print an object.

### BRIEF INTRODUCTION OF THE DRAWINGS

Examples implementations are described below with reference to the accompanying drawings, in which:

FIG. 1 shows a photograph of fresh and aged build material;

FIG. 2 illustrates a stability relationship according to some examples;

FIG. 3 depicts example methods according to some examples;

FIG. 4 illustrates an example of a workflow according to some examples; and

FIG. 5 shows machine readable storage and machine executable instructions according to an example.

### DETAILED DESCRIPTION

It may be desirable to develop and use printing materials for use in three dimensional (3D) with a high degree of recyclability. Doing so may help to reduce the total cost per part printed by a 3D printer, because non-fused powder or other build material, which is deposited for use in printing a 3D part but not fused to print the 3D part, may be reused build after build. Generally, recycled material may be added to fresh material to print a subsequent part. The mixing ratio of fresh build material to recycled build material may follow a predefined mixture ratio.

High temperatures used during the manufacturing process may lead to thermal and thermo oxidative aging of the build material (e.g. a polyamide powder). This material aging may affect to the final part quality, for example by affecting the mechanical properties of the part. Material aging may affect printing using thermal printheads, and may affect printing using piezo printheads, since both methods may use variations in temperature of the build material/powder.

An optimum ratio (or an optimum range of ratios) of fresh material to recycled material to use to print a 3D part, to maximize the part quality and reduce the cost per part, may be obtained and may vary for different parts (for example, parts of different packing ratio or different sizes). The nature (type) of build material may also be a determining factor in the optimal range of ratios of fresh material to recycled material suitable for use in printing the part. However, a fixed ratio of fresh material to recycled mixture is generally used regardless of the part being printed.

Examples disclosed herein allow for a ratio of fresh material to recycled material suitable for the object being printed to be used, to help prevent part quality degradation due to aging of the material and to increase the proportion of recycled build material used to print parts. Examples disclosed herein allow for 3D printing of an object to be performed with a suitable fresh:recycled blend of build material, depending, for example, on the build packing density and the height of the printed plot.

Throughout this disclosure, the terms build density and packing density are used interchangeably. Similarly, an object printed using 3D printing may be referred to an object, item, part or plot. Powder (e.g. polyamide powder) is discussed as an example of a build material used for 3D printing. Further, references to build material, material, and powder may be made interchangeably and refer to the material, such as polyamide powder, to be fused with the addition of printing liquid (e.g. ink) in the printing process.

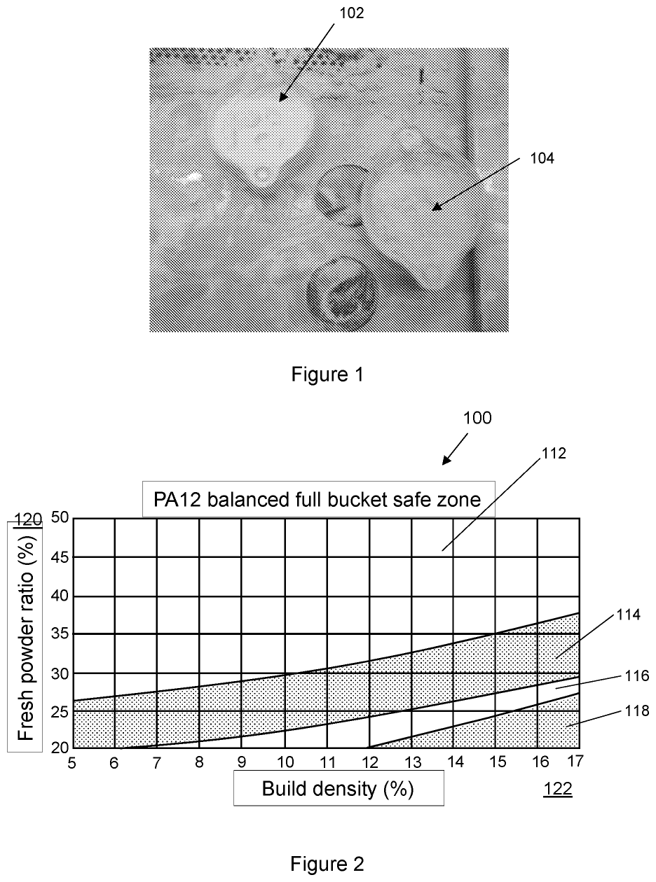

FIG. 1 shows a photograph of fresh build material 102 and aged build material 104. The build material in this example is polyamide 12 (PA12).The aged material 104 in this example is what remains after being used in a print job to print an object with a 13% packing density. The fresh material 102 has a white colour while the aged material 104 has a light yellow-brown colour. Other build materials which may behave similarly in terms of degradation of material quality include polyamide 11 (PA11). Build materials which may be used in methods disclosed herein include powders, plastics, ceramics, metal powders, powder-like materials, and blends or combinations of one or more of such materials. Other build materials which may be used in methods disclosed herein include short fibre build materials. In some examples the build material powder may be formed from, or may include, short fibres that may, for example, have been cut into short lengths from long strands or threads of material.

The aged material 104 has degraded because it has been used in at least one previous printing run (but was not fused to form part of the resulting printed object). The use of recycled powder is acceptable where the powder has not undergone thermal stress to the extent that the fusing and mechanical properties of an object printed using the recycled powder are unaffected (within an acceptable tolerance range). However, using aged powder to print an object, in which the powder has undergone thermal stress and thermo-oxidation, may result in a printed object having substandard mechanical properties, or even broken parts, such that the object cannot be safely used as intended. For example, the object may crack under stress which it is subjected to in normal use, whereas the same object printed with fresh material would not crack under the same stress.

The mixing ratio of fresh to recycled material may be adjusted to reduce the production of low quality printed parts having too high a proportion of aged material. The ratio of fresh to recycled material which may be used to print having acceptable mechanical properties depends on the packing ratio of the object (acceptable mechanical properties may be taken to be one or more particular mechanical properties having a value at or exceeding a predetermined threshold value).

Examples disclosed herein allow for the mixing ratio of fresh to recycled powder to be tuned according to the object being printed, to improve the amount of recycled power which can be used to print object having acceptable mechanical properties. In some examples, the mixing ratio is determined based on a predetermined stability relationship such as that shown in FIG. 2, between a ratio of fresh to recycled build material and a packing density. The plot 100 of FIG. 2 shows a series of object packing density—powder degradation curves 112, 114, 116, 118. The data shown in FIG. 2 shows how the part quality can become compromised depending on the build density of the object 122, and the proportion of fresh powder used to print the object 120.

The example relationship 100 shown in FIG. 2 relates to the build material PA12. Similar types of relationships may be used for different build materials such as PA11.

For higher build densities 122, the percentage of fresh powder in the mixture 120 should be higher to achieve suitably high mechanical properties (i.e. and be within the safe band 112). The safe band 112 in FIG. 2 shows that at a build density of 12%, a minimum amount of fresh powder of around 32% should be used to safely print the object having acceptable properties. As the build density rises to 17%, a minimum amount of fresh powder also increases to around 37% to obtain an object having acceptable properties.

Generally in examples disclosed herein, the predetermined stability relationship 100 indicates a proportion of fresh build material 120 in the ratio of fresh to recycled build material increases as the packing density 122 increases. In some examples, determining the mixing ratio of fresh to recycled build material 120 to use for printing an object comprises determining a maximum proportion of recycled build material in the mixing ratio, which, when used to print an object, provides a stable object having a build quality above a predetermined stability threshold. For example, for an object having a packing density of 14%, an amount of fresh build material above 33% may be used to achieve an object having a build quality above a predetermined stability threshold, as this point lies between the stable 112 and less stable 114 regions of the relationship 100.

In the “possibly safe” region 114, for example, at a build density of 12%, an amount of fresh powder between around 23% and around 32% may be used to print the object, but there may be degradation due to the higher proportion of recycled powder in the build material. For example, printing with a build material having a proportion of fresh material in the “possibly safe” region 114, some printed plots may be acceptable but after one or more print runs, the build material may start to degrade and the printed plots may be of unacceptable low quality. The risk of low quality plots may be higher if the plot is more demanding and/or difficult (e.g. having small details or complex shapes).

In the “not recommended zone” 116, for example at a build density of 12%, using an amount of fresh powder between around 20% and around 23% to print the object is considered to be unrecommended, because the resulting printed part is likely to have unacceptably low mechanical properties. In the “non-sustainable” zone 118, the level of fresh material is too low to be sustainable. It is not sustainable to print several continuous jobs with a build material having a fresh:recycled ratio and packing density in the “non-sustainable” zone 118 because more recycled build material is called for than is generated by the print runs. That is, not enough material remains to be recycled for a subsequent print job after printing a job at a packing density in the “non-sustainable” zone 118 to provide a fresh:recycled ratio in the zone 118.

Generally, in examples disclosed herein, the predetermined stability relationship 100 between a ratio of fresh to recycled build material and a packing density defines a stable region 112 representing a first range of ratios of fresh to recycled build material 120 and a first range of packing densities 122, wherein printing an object according to a ratio and packing density in the stable region provides a stable object having a build quality above a predetermined stability threshold; and an unstable region 114, 116 representing a second range of ratios of fresh to recycled build material 120 and a second range of packing densities 122, wherein printing an object according to a ratio and packing density in the unstable region provides an unstable object having a build quality below a predetermined stability threshold. In some examples, the predetermined stability relationship 100, as in the example of FIG. 2, may also indicate an unsustainable region 118 representing a third range of ratios of fresh to recycled build material 120 and a third range of packing densities 122, wherein printing an object according to a ratio and packing density in the unsustainable region 118 is not possible because of an unsustainable refresh ratio. An unsustainable refresh ratio a set of fresh:recycled build material ratios having a corresponding set of packing densities in which, following printing an object, there is insufficient build material remaining to be recycled for printing a subsequent object at the packing ratio for that object. Recycled material for subsequent print jobs is not generated in sufficient amounts from previous print jobs.

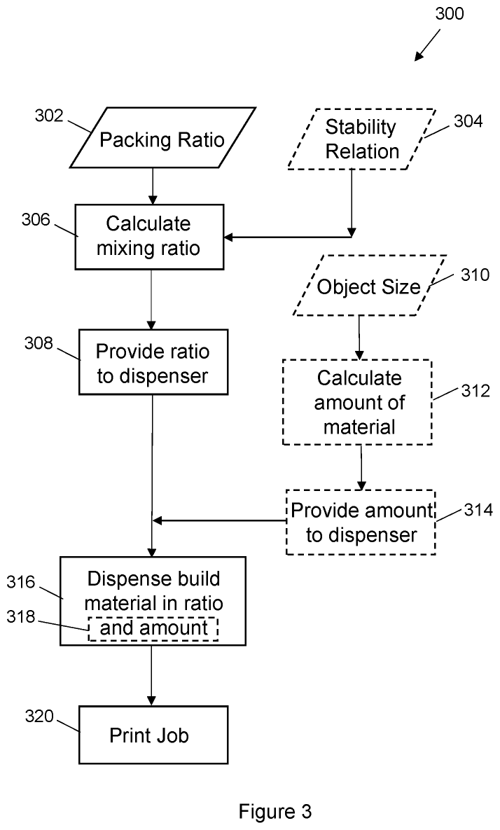

An example method 300 for 3D printing is shown in FIG. 3. A packing ratio of an object to be printed is received 302. An example of receiving a packing ratio is of a processing station, printer, server, cloud, or other computing device receiving a packing ratio as a data field in a job file defining how the object to be printed is to be printed. Another example of receiving a packing ratio is of a computing device (e.g. a processing station, printer, server, or cloud) analysing a job file defining the object to be printed and determining, for example from the object dimensions, what the packing ratio of the object is.

Based on the packing ratio, a mixing ratio of fresh to recycled build material to use for printing the object is determined 306. For example, this may be according to a predetermined stability relationship 304 between a ratio of fresh to recycled build material and a packing density as discussed in relation to FIG. 2.

The mixing ratio is provided to a dispenser 308. The dispenser may then dispense fresh and recycled build material in the provided mixing ratio for printing the object 316. In some examples the build material is dispensed in an amount sufficient for the object to be printed with no surplus build material remaining following printing the object 318.

In examples in which build material is dispensed in a particular amount 318, a size of the object may be received 310. In some examples a computing device (e.g. processing station, printer) may receive the size of the object as a data field in a job file defining how the object to be printed is to be printed. Another example of providing the size for determining an amount of build material to dispense is to calculate the amount, for example, by analysing a job file defining the object to be printed and determining, for example from the object dimensions, what the amount of material for printing the object is.

The received object size is used to determine an amount of material for printing the object at the received size 312. The calculated amount of build material is then provided to the dispenser 314 to dispense the calculated amount of fresh and recycled build material in the determined mixing ratio 316 and in the determined amount 318 for printing the object 320.

To dispense the amount of build material, an amount of the fresh build material and an amount of the recycled build material for printing the object at a specified object size 318 and according to the determined mixing ratio 316 are dispensed. The fresh and recycled materials may be dispensed in an empty container (e.g. a bucket). After the object is printed at the specified size, the container may be empty. Thus no surplus material is dispensed, and the amount (and no more) to print the object is dispensed. In this way there is no need to clean out the dispensing bucket or print tray/trolley to remove ay build material having a mixing ratio which is not suitable for an upcoming print job.

Following dispensing of the build material 316 the job may by 3D printed using the build material 320. Printing the object may be performed using layer by layer printing in which the following stages are performed and repeated until the object is printed: dispensing a layer of build material (e.g. powder) having the determined mixing ratio; applying printing liquid to the layer of building material; and applying energy to the layer of building material to melt the dispensed build material where the printing liquid was applied. Examples of printing liquid include a fusing agent, a detailing agent, a coloured liquid, an ink, a transparent liquid, and a printing liquid comprising a dopant. A fusing agent causes build material to fuse where the agent is applied and the build material does not fuse where no agent is applied. A detailing agent is an agent which may be used to remove rough or unfinished edges from the printed object.

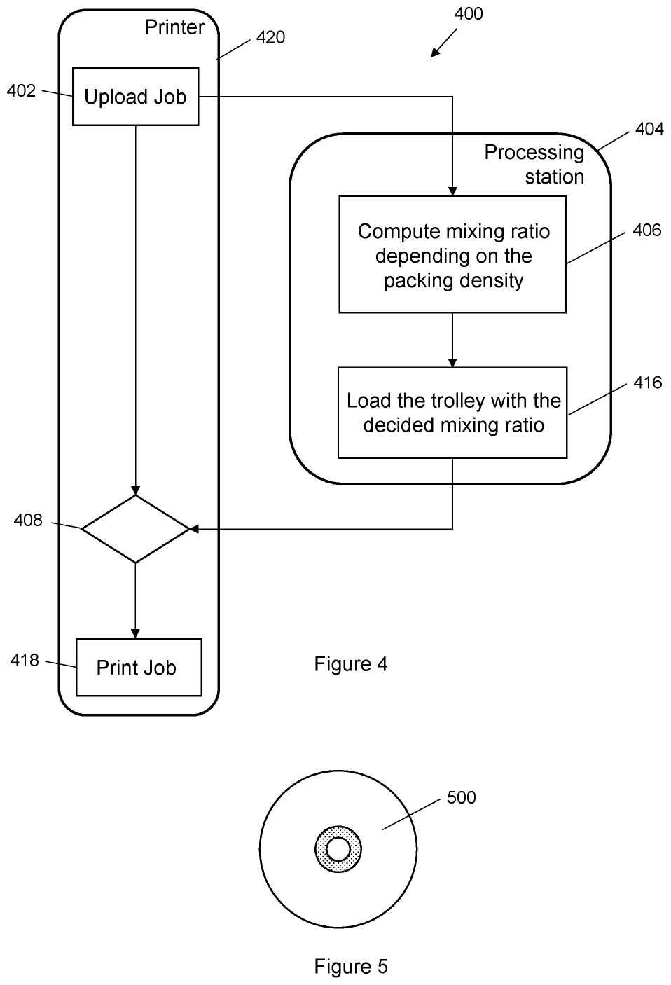

The abovementioned methods may be performed, for example, by a processing station, printer, server, or cloud, and data communication may take place between such computing entities. It will be understood that certain computing entities (e.g. a processing station and a printer) may communicate by wireless or wired communication, and certain computing entities (e.g. a computer and the cloud) may communicate wirelessly. The methods described in relation to FIG. 3 may be performed, for example, by a system of a processing station and a printer (this is discussed in relation to FIG. 4), or for example, by a single processing and printing device. The abovementioned methods may be used in both systems using a separate processing station and printer (described more in relation to FIG. 4) and systems in which the processing and printing take place in the same apparatus.

FIG. 4 illustrates an example of a workflow between a printer 420 and a processing station 404 according to some examples. In this example the processing station 404 and the printer 420 are two separate independent systems but are in data communication with each other (either wired or wirelessly). In other cases in which the processing station and printer are not in communication, the processing station does not have data on the characteristics of the plot, and the printer doesn't know what materials are loaded on the printing unit. Therefore, the example of FIG. 4 allows for methodology for use with a separate processing station and printer, which helps to ensure that the mixing ratio load is the one that will give the best results in terms of reduced powder degradation and acceptable mechanical properties for that specific job.

In the example of FIG. 4, the plot/job (i.e. details of the object to be printed) is uploaded 402 to the printer 420. The processing station 404 is communicably connected to the printer 420 and it can access the information of the next job to be printed. This allows the processing station 404 to identify the packing density of the plot and the amount of build material to print the plot (for example, as a height/depth of build material to be held in a dispensing bucket of standard dimensions).

The processing station 404 in this example can access the packing density and amount information from the printer 420. In some examples, the processing station 404 can access this information via a remote server or the cloud. In some examples, the processing station 404 may retrieve plot details from the printer and may calculate the packing density and/or the amount from the retrieved plot details. The processing station 404 may also access a predetermined stability relationship (e.g. a plot including stable zone curves as in FIG. 2). The predetermined stability relationship may be stored, for example, at the processing station, at the printer, or remotely at a server or the cloud.

In this example, the processing station 404 is able to calculate a best mixing ratio 406 and the amount of material needed for the job which provides acceptable mechanical properties of the printed object and which uses all the build material deposited for printing the plot. This calculation is made dependent on the packing density and the size of the plot. In other cases, where the bucket for dispensing material is filled completely instead of being filled with the amount of material for printing the next job, the remaining material in the bucket may not be in the correct mixing ratio for an upcoming print job, and the bucket will need to be cleaned before re-filling with material in a new mixing ratio.

The processing station 404 in this example then loads the trolley (of the printing unit) with the computed mixing ratio in the determined amount 416. The printing unit will be filled with this mixing ratio and the amount of powder for the application.

The trolley is then transferred 408 to the printer 420, and the printer 420 will print the job in the trolley filled with the amount of material, and in the determined mixing ratio, to mitigate against powder aging and obtain good performance on mechanical properties.

In examples using a 3D printer 420 and a separate powder management station 404, a moveable build unit may be filled with powder in an appropriate mix at the powder processing station 404 and then moved to the 3D printer 420 which uses the build material mix provided to generate the 3D objects. Examples such as this may link the print job (which defines the packing density of the objects to be printed) to be printed by the printer 420, and the powder management station 404. The powder management station 404 may receive the details of the print job that will be printed in the specific build unit so that the appropriate determined mix of build material can be loaded into the build unit, and the build unit may then be transferred to the printer 420. This may be achieved, for example, by linking an ID of the print job to the ID of a build unit so that the correct build unit (containing the determined mixture of build material) is used to print the corresponding print job. In some examples there may be a fixed build unit rather than a moveable build unit. In examples in which the build material dispensing and printing take place in the same device, there may not be an ID link or similar between the build unit and the print job, since methods as disclosed herein take place in the same device.

FIG. 4 may be considered to represent a three-dimensional, 3D, printing system 400 comprising a processing station 404 and a printer 420 communicably connected with the processing station 404, wherein the processing station 404 is to receive object data of an object to be printed 402; determine a mixing ratio 406 of fresh to recycled build material to use for printing the object based on the determined packing ratio; cause fresh and recycled build material to be dispensed 416 according to the determined mixing ratio; and wherein the printer 420 is to print the object 418 using the dispensed build material having the determined mixing ratio. In some examples the processing station 404 is to determine the packing ratio of the object based on the received object data.

In examples where it is desired to print an object with a high packing ratio (e.g. above 20%, above 25%, or above 30% packing ratio), the abovementioned procedures may help provide build material for printing which has stable powder properties due to varying the ratio of fresh to recycled powder depending on the packing ratio. Compared with methods which use a fixed mixing ratio of 80:20 recycled:fresh build material mix, the stability of the resulting printed objects may be improved and the amount of waste from unstable powder an objects printed with substandard mechanical properties may be reduced.

FIG. 5 illustrates computer readable storage 500. Disclosed herein is an apparatus (e.g. the apparatus 400 of FIG. 4, or a single apparatus/device performing the method shown in FIG. 4), wherein the apparatus comprises a processor and a computer readable storage 500 coupled to the processor; and an instruction set to cooperate with the processor and the computer readable storage 500. The instruction set is to receive a packing ratio 302 of an object to be printed; based on the received packing ratio, determine a mixing ratio 306 of fresh to recycled build material to use for printing the object; and provide the mixing ratio 308 to a dispenser to dispense fresh and recycled build material in the provided mixing ratio for printing the object.

In some examples, the instruction set is to cooperate with the processor and the computer readable storage to dispense fresh and recycled build material 316 in the provided mixing ratio for printing the object. In some examples, the instruction set is to cooperate with the processor and the computer readable storage to dispense an amount of the fresh build material and an amount of the recycled build material for printing the object at a specified object size 318 and according to the determined mixing ratio in an empty container wherein, after the object is printed at the specified size 320, the container is empty. In other examples, the printing system 400 of FIG. 4 may perform any other method disclosed herein.

FIG. 5 may be considered to show a computer readable storage medium having executable instructions stored thereon which, when executed by a processor, cause the processor to perform any method disclosed herein. The machine readable storage 500 can be realised using any type or volatile or non-volatile (non-transitory) storage such as, for example, memory, a ROM, RAM, EEPROM, optical storage and the like.

Procedures and apparatus disclosed herein may help the transition from using a fixed mixing ratio of, or example, 80% recycled and 20% fresh powder, to a variable mixing ratio. While a fixed ratio of 80:20 may be suitable for use for a wide range of packing densities, a variable ratio may, discussed above, allow the amount a recycled powder to be increased, thereby reducing wastage, while ensuring the resulting printed plots have acceptable mechanical properties. Predetermined stability relations such as the powder oxidation curve shown in FIG. 2 may be used for all plots/print jobs to help increase the amount of recycled material used. The end user need not be concerned with which mixing ratio to use since the process is completely automated at the printing system.

By using the amount of material for printing a particular plot, and no more, as determined from the size of the plot, the need to do a ‘clean’ of the print bucket when another mixing ratio is to be used is avoided, thereby improving the efficiency of printing, for example a print run of a plurality of objects which may not all use the same mixing ratio. The amount of degraded powder is reduced and in some examples may be eliminated from 3D printing, such as multi-jet fusion (MJF) printing, automatically. The yield from the printing system is also increased, by decreasing the number of parts that could be affected due to the aging powder process and decreasing the amount of powder wastage due to ageing. This in turn reduces the total cos of ownership (TCO).

Throughout the description and claims of this specification, the words “comprise” and “contain” and variations of them mean “including but not limited to”, and they are not intended to (and do not) exclude other components, integers or elements. Throughout the description and claims of this specification, the singular encompasses the plural unless the context suggests otherwise. In particular, where the indefinite article is used, the specification is to be understood as contemplating plurality as well as singularity, unless the context suggests otherwise.

1. A method comprising:
receiving a packing ratio of an object to be printed;
based on the received packing ratio, determining a mixing ratio of fresh to recycled build material to use for printing the object; and
providing the mixing ratio to a dispenser to dispense fresh and recycled build material in the provided mixing ratio for printing the object.

2. The method of claim 1, comprising:
receiving a size of the object; and
using the received size of the object and the determined mixing ratio to determine an amount of fresh build material and an amount of recycled build material to print the object at the received size.

3. The method of claim 1, wherein determining the mixing ratio is further based on a predetermined stability relationship between a ratio of fresh to recycled build material and a packing density.

4. The method of claim 3, wherein the predetermined stability relationship indicates a proportion of fresh build material in the ratio of fresh to recycled build material increases as the packing density increases.

5. The method of claim 3, wherein the predetermined stability relationship between a ratio of fresh to recycled build material and a packing density defines:
a stable region representing a first range of ratios of fresh to recycled build material and a first range of packing densities, wherein printing an object according to a ratio and packing density in the stable region provides a stable object having a build quality above a predetermined stability threshold; and
an unstable region representing a second range of ratios of fresh to recycled build material and a second range of packing densities, wherein printing an object according to a ratio and packing density in the unstable region provides an unstable object having a build quality below a predetermined stability threshold.

6. The method of claim 1, wherein determining the mixing ratio of fresh to recycled build material to use for printing the object comprises determining a maximum proportion of recycled build material in the mixing ratio, which, when used to print an object, provides a stable object having a build quality above a predetermined stability threshold.

7. The method of claim 1, comprising calculating the packing density of the object from object data defining the object to be printed.

8. The method of claim 1, comprising:
dispensing the fresh and recycled build material in the provided mixing ratio for printing the object.

9. The method of claim 1, comprising:
dispensing an amount of the fresh build material and an amount of the recycled build material to print the object at a specified object size and according to the determined mixing ratio in an empty container, wherein, after the object is printed at the specified size, the container is empty.

10. The method of claim 1, comprising printing the object layer by layer by repeatedly:
dispensing a layer of build material having the determined mixing ratio;
applying printing liquid to the layer of building material; and
applying energy to the layer of building material to melt the dispensed build material where the printing liquid was applied;
until the object is printed.

11. An apparatus comprising:
a processor;
a computer readable storage coupled to the processor; and
an instruction set to cooperate with the processor and the computer readable storage to:
receive a packing ratio of an object to be printed;
based on the received packing ratio, determine a mixing ratio of fresh to recycled build material to use for printing the object; and
provide the mixing ratio to a dispenser to dispense fresh and recycled build material in the provided mixing ratio for printing the object.

12. The apparatus of claim 11, wherein the instruction set is to cooperate with the processor and the computer readable storage to:
dispense fresh and recycled build material in the provided mixing ratio for printing the object.

13. The apparatus of claim 11, wherein the instruction set is to cooperate with the processor and the computer readable storage to:
dispense an amount of the fresh build material and an amount of the recycled build material to print the object at a specified object size and according to the determined mixing ratio in an empty container wherein, after the object is printed at the specified size, the container is empty.

14. A non-transitory computer readable storage medium having executable instructions stored thereon which, when executed by a processor, cause the processor to:
obtain a packing ratio of an object to be printed using object data;
determine a mixing ratio of fresh to recycled build material for use in printing the object based on the packing ratio;
determine an amount of fresh build material and an amount of recycled build material to print the object at a specified object size and according to the determined mixing ratio; and
provide the determined amount of fresh build material and amount of recycled build material mixing ratio to a dispenser to dispense the fresh and recycled build materials for printing the object.

15. A three-dimensional, 3D, printing system comprising:
a processing station; and
a printer communicably connected with the processing station;
wherein the processing station is to:
receive object data of an object to be printed;
determine a packing ratio of the object based on the received object data;
determine a mixing ratio of fresh to recycled build material to use for printing the object based on the determined packing ratio;
cause fresh and recycled build material to be dispensed according to the determined mixing ratio; and
wherein the printer is to:
print the object using the dispensed build material having the determined mixing ratio.
